(19) United States
(12) Patent Application Publication
(10) Pub. No.: US 2018/0199357 A1
(43) Pub. Date: Jul. 12, 2018

(54) SYSTEM FOR TRANSMITTING AIRCRAFT DATA TO GROUND STATION(S) VIA ONE OR MORE COMMUNICATION CHANNELS

(71) Applicant: HCL Technologies Limited, Noida (IN)

(72) Inventors: Jayaramakrishnan SUNDARARAJ, Bangalore (IN); Sourav DEY, Bangalore (IN); Senthilkumar VINAYAGAM, Chennai (IN)

(21) Appl. No.: 15/856,916

(22) Filed: Dec. 28, 2017

(30) Foreign Application Priority Data
Jan. 12, 2017 (IN) 201711001331

(51) Int. Cl. H04W 72/12; H04B 7/185; H04W 84/06

(52) U.S. Cl. CPC H04W 72/1242; H04W 76/15; H04W 84/06; H04B 7/18506

(57) ABSTRACT

Disclosed is a Central Aircraft Network System (CANS) for transmitting data, associated with an aircraft, to a ground station via one or more communication channels. A data receiving module receives data from at least one data source. An AIDPS determines priority information pertaining to the data. In one aspect, the priority information may be determined by analyzing the data and a predefined data pattern model. An ICSMS determines one or more communication channels, of a plurality of communication channels, to be used for transmitting the data. The ICSMS further establishes the one or more communication channels between the aircraft and a ground station in order to transmit the data to the ground station via the one or more communication channels.

### CROSS REFERENCE TO RELATED APPLICATIONS

This patent application claims priority from Indian Application No. 201711001331 filed on Jan. 12, 2017 the entirety of which is hereby incorporated by reference.

### TECHNICAL FIELD

The present subject matter described herein, in general, relates to a method and system for transmitting data, associated with an aircraft, to a ground station. More specifically to the method and system for transmitting the data via one or more communication channels.

### BACKGROUND

It may be noted that many aircraft accidents have occurred due to disruption in communication between ground station(s), including Air Traffic Control (ATC) room(s), and aircrafts. Nowadays the communication between the aircraft and the ground station has improved significantly because of robust and efficient communication infrastructure and rapid development in a satellite communication network. As a result, the aircrafts are able to report their position to Flight Information Region (FIR) or the ATC room. It may be noted that position may be reported more frequently when the aircraft is transiting through an oceanic region. However, the reporting of aircraft's position to the FIR and/or the ATC room is very expensive and thereby increases the overall operational cost. In view of incurring operational cost, weather report(s) are not sent frequently to the ground station. In other words, flight information (such as position-altitude-latitude-longitude, airspeed, heading, and vertical speed), when sent to ground station more frequently, may increase overall system safety.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for transmitting data, associated with an aircraft, to a ground station via one or more communication channels and the concepts are further described below in the detailed description. This summary is not intended to identify essential features of the claimed subject matter nor is it intended for use in determining or limiting the scope of the claimed subject matter.

In one implementation, a Central Aircraft Network System (CANS) for transmitting data, associated with an aircraft, to a ground station via one or more communication channels is disclosed. The CANS may include a processor and a memory coupled to the processor. The processor may execute a plurality of modules present in the memory. The plurality of modules may include a data receiving module, an Artificial Intelligence based Data Processing System (AIDPS), and an Intelligent Communication Network Selection and Maintenance Service (ICSMS). The data receiving module may receive data from at least one data source. The AIDPS may determine priority information pertaining to the data. In one aspect, the priority information may be determined by analyzing the data and a predefined data pattern model. In one embodiment, the data may be analyzed by using machine learning algorithms. The ICSMS may determine one or more communication channels, of a plurality of communication channels, to be used for transmitting the data. In one aspect, the one or more communication channels may be determined based on the priority information. The ICSMS may further establish the one or more communication channels between the aircraft and a ground station in order to transmit the data to the ground station via the one or more communication channels.

In another implementation, a method for transmitting data, associated with an aircraft, to a ground station via one or more communication channels is disclosed. In order to transmit the data to the ground station, initially, data may be received from at least one data source. Upon receipt of the data, priority information pertaining to the data may be determined. In one aspect, the priority information may be determined by analyzing the data and a predefined data pattern model. In one embodiment, the data may be analyzed by using machine learning algorithms. Subsequent to the determination of the priority information, one or more communication channels, of a plurality of communication channels, to be used may be determined for transmitting the data. In one aspect, the one or more communication channels may be determined based on the priority information. After determination of the one or more communication channels, the one or more communication channels may be established between the aircraft and the ground station in order to transmit the data to the ground station via the one or more communication channels. In one aspect, the aforementioned method for transmitting the data, associated with the aircraft, to the ground station via the one or more communication channels may be performed by a processor using programmed instructions stored in a memory.

In yet another implementation, non-transitory computer readable medium embodying a program executable in a computing device for facilitating an analytics framework for connected vehicles to perform analytics on data, captured from disparate connected vehicles, in order to deduce meaningful information is disclosed. The program may include a program code for receiving data from at least one data source. The program may further include a program code for determining priority information pertaining to the data, wherein the priority information is determined by analyzing the data and a predefined data pattern model, and wherein the data is analyzed by using machine learning algorithms. The program may further include a program code for determining one or more communication channels, of a plurality of communication channels, to be used for transmitting the data, wherein the one or more communication channels is determined based on the priority information. The program may further include a program code for establishing the one or more communication channels between the aircraft and a ground station in order to transmit the data to the ground station via the one or more communication channels.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates an implementation of Central Aircraft Network System (CANS) within an aircraft, in accordance with an embodiment of the present subject matter.

FIG. 2 illustrates the CANS, in accordance with an embodiment of the present subject matter.

FIG. 3 illustrates an example, in accordance with an embodiment of the present subject matter.

FIG. 4 illustrates an aircraft deployed with a plurality of aircraft transceivers, in accordance with an embodiment of the present subject matter.

FIG. 5 illustrates a method for transmitting data to the ground station via one or more communication channels, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed system, hereinafter may referred to as a Central Aircraft Network System (CANS), includes an application framework for transmitting data, associated with an aircraft, to a ground station via one or more communication channels. In one aspect, the data may be associated to a plurality of aircraft sub-systems hereinafter may also refer to as a data source. The system may coordinate with the data source to capture the data. Examples of the data source may include, but not limited to, engine, auxiliary power unit and air-data inertial reference system, High Priority Aircraft Network of System (NoS), an External Communication Monitoring System, an Aircraft Transponder, an Aircraft Transceiver, a Turbine NoS, Seat based NoS, a Passenger NoS, an In-flight entertainment (IFE) NoS, a Security NoS, a cargo monitoring NoS, an electrical subsystem, and a Temperature Monitoring NoS.

In one embodiment, the system may be connected with the plurality of aircraft sub-systems to form an Aircraft Network of System/Things (ANoS) communication interface with outer world. Examples of the aircraft NoS communication interface may include, but not limited to, Aeronautical Radio Incorporated (ARINC™) interface standards, Avionics Full-Duplex Switched Ethernet (AFDX), Controller Area Network (CAN), wireless and power line modems inside the aircraft to connect avionics systems and handheld devices. It may be noted that ARINC™ is an interface that may facilitate to operate aircraft system and services.

Upon capturing the data, the data captured may then be grouped into different categories based on avionics systems, priority, and criticality. Subsequent to the categorization of the data, the system may determine the one or more communication channels. Examples of the one or more communication channels may include, but not limited to, Satellite Communication (SATCOM) channel, Direct Air to Ground Communication (DA2GC) channel, and Aircraft to Aircraft Communication (A2A) channel. After determination of the one or more communication channels, the system establishes the one or more communication channels between the aircraft and the ground station in order to transmit the data to the ground station via the one or more communication channels.

While aspects of described system and method for transmitting the data, associated with the aircraft, to the ground station via the one or more communication channels and may be implemented in any number of different computing systems, environments, and/or configurations, the embodiments are described in the context connected vehicles.

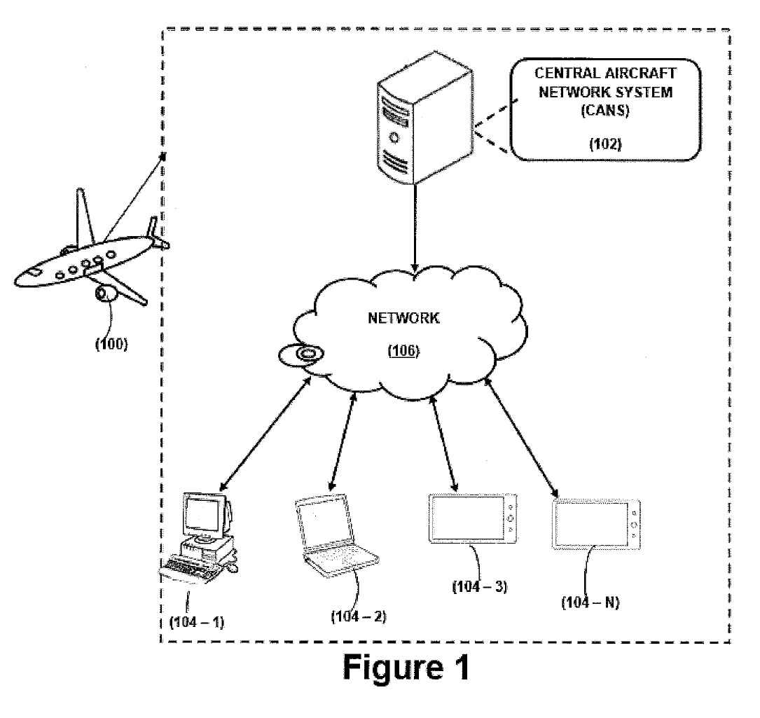

Referring now to FIG. 1, an implementation of Central Aircraft Network System (CANS) 102 within an aircraft 100 is disclosed. In order to transmit the data to the ground station, initially, the CANS 102 receives the data from at least one data source. Upon receipt of the data, the CANS 102 determines priority information pertaining to the data. In one aspect, the priority information may be determined by analyzing the data and a predefined data pattern model. In one embodiment, the data may be analyzed by using machine learning algorithms. Subsequent to the determination of the priority information, the CANS 102 determines one or more communication channels, of a plurality of communication channels, to be used for transmitting the data. In one aspect, the one or more communication channels may be determined based on the priority information. After determination of the one or more communication channels, the CANS 102 establishes the one or more communication channels between the aircraft and the ground station hi order to transmit the data to the ground station via the one or more communication channels.

It may be understood that the present disclosure is explained considering that the CANS 102 is implemented on a variety of computing systems, such as a mainframe computer, and a server. It will be understood that the CANS 102 may be accessed by multiple users through one or more user devices 104-1, 104-2, 104-3, 104-N, collectively referred to as authorized user 104 or stakeholders, hereinafter, or applications residing on the user devices 104. In one aspect, the authorized and registered users, of the user devices 104, may transmit and/or received the data to and from the CANS 102. Examples of the user devices 104 may include, but are not limited to, Air Traffic Management (ATM) system, Ground Network Systems, a portable computer, a personal digital assistant, a handheld device, a workstation, and other systems. The user devices 104 are communicatively coupled to the CANS 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

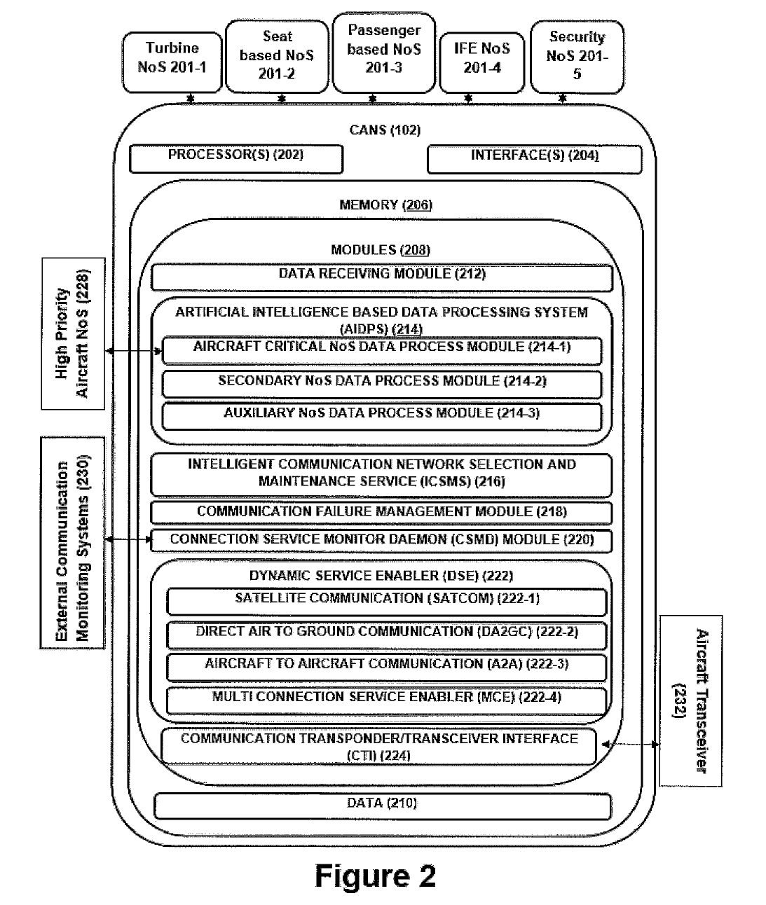

Referring now to FIG. 2, the CANS 102 is illustrated in accordance with an embodiment of the present subject matter. In one embodiment, the CANS 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the CANS 102 to interact with the user directly or through the client devices 104. Further, the 110 interface 204 may enable the CANS 102 to communicate with other computing devices, such as web servers and external data servers (not shown). The I/O interface 204 can facilitate multiple communications within a wide variety of networks and protocol types, including ARINC™ protocols, wired networks, for example, LAN, cable, etc., and wireless networks, such as WLAN. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data receiving module 212, an artificial intelligence based data processing system (AIDPS) 214, an intelligent communication network selection and maintenance service (ICSMS) 216, a communication failure management module 218, a connection service monitor daemon (CSMD) module 220, a Dynamic Service Enabler (DSE) 222, a Communication Transponder/Transceiver Interface (CTI) 224 and other modules.

The AIDPS 214 may further comprise an Aircraft Critical NoS Data Process module 214-1, a Secondary NoS Data Process module 214-2, and an Auxiliary NoS Data Process module 214-3. The DSE 222 may further comprise a Satellite Communication (SATCOM) 222-1, a Direct Air to Ground Communication (DA2GC) 222-2, Aircraft to Aircraft Communication (A2A) 222-3, and Multi Connection Service Enabler (MSE) 222-4. The other modules may include programs or coded instructions that supplement applications and functions of the CANS 102. The modules 208 described herein may be implemented as software modules that may be executed in the cloud-based computing environment of the CANS 102. The data 210, amongst other things, serves as a repository for storing data processed, received, and generated by one or more of the modules 208. As there are various challenges observed in the existing art, the challenges necessitate the need to build the CANS 102 for transmitting data, associated with the aircraft, to the ground station via one or more communication channels.

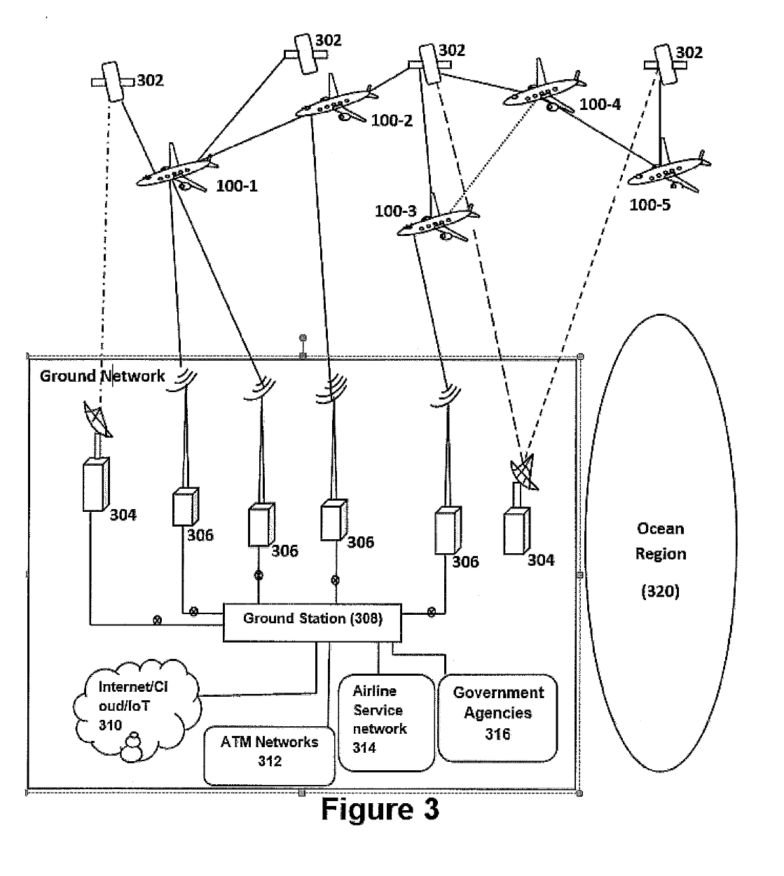

Now referring to FIGS. 2 and 3. The CANS 102 for transmitting data, associated with an aircraft 100, to a ground station 308 via one or more communication channels is disclosed. In one aspect, the CANS 102 may act as a central point of connection for a plurality data source (hereinafter may referred to as a device, one or more devices, a plurality of devices, or an Aircraft Network of System (ANoS)) and the ground station 308. The plurality data source may include, but not limited to, turbine Network of System (NoS) 201-1, seat based NoS 201-2, passenger based NoS 201-3, Might Entertainment (IFE) NoS 201-4, Security NoS 201-5, a High Priority Aircraft NoS, an External Communication Monitoring System, an Aircraft Transponder, an Aircraft Transceiver, health monitor, auto pilot system, pilot monitor device, black box, geared turbo fan engine, cockpit avionic NoS, passenger devices, navigation subsystems, electric power system, wings machine and monitor, flight control systems, fuel systems, potable water systems, Flight onboard security system, Fire alarm and suppression equipment, other subsystems. The ground station, on the other hand, may include Internet of Things (IoT) devices 310, ATM networks 312, an Airline Service Network 314, and Government Agencies 316.

It may be understood that the CANS 102 may also act as a central control and service management system between the ground station 308 and different aircraft systems (such as a High Priority Aircraft NoS 228, an External Communication Monitoring Systems 230, and an aircraft transceiver/transponder 232), as shown in the FIG. 2.

Each of the aforementioned data source (including the aircraft systems) is capable of generating a continuous stream of data. It may be understood that the data generated may be useful for management of the aircraft 100 at different levels. The data generated by the plurality of data source, hereinafter also referred to as Aircraft Network of System (ANoS), initially, may be transmitted to the CANS 102. In one embodiment, the data may be transmitted to the CANS 102 via the I/O interfaces 204. In addition to the examples of the I/O interfaces as aforementioned, other examples of the I/O interfaces may include, but not limited to, coax cable, RS232, and other wires or wireless means. To effectively monitor and manage various subsystems, of the aircraft 100, from the ground station 308 or anywhere and anytime, a resilient, reliable and efficient central control system (i.e. the CANS 102) is provided for transmitting the data to the ground station 308 via the one or more communication channels.

In order to transmit the data, the CANS 102 may employ the data receiving module 212, the AIDPS 214, the ICSMS 216, the communication failure management module 218, the connection service monitor daemon (CSMD) module 220, the dynamic service enabler 222, and the CTI 224. The detail functioning of the modules 208 are described below with the help of figures.

In one aspect, the data receiving module 212 includes an application framework which enables a hardware system to coordinate with the plurality of data source, as aforementioned. The receiving module 212 may be connected with the plurality of data source via the I/O interfaces 204. The communication interface facilitates the data receiving module 212 to receive the data from each of the plurality of data source in a continuous manner. Upon receiving the data, the AIDPS 214 determines priority information pertaining to the data. The priority information may be determined by analyzing the data with a predefined data pattern model by using machine learning algorithms.

In one embodiment, the AIDPS 214 determines the priority information by comparing the data with the predefined data pattern model. After comparison, the AIDPS 214 associates a priority flag with the data when the data is distinct from the predefined data pattern model. In one aspect, the priority flag may indicate the data comprises priority data. Subsequent to the determination of the priority information, the ICSMS 216 determines the one or more communication channels, of a plurality of communication channels, to be used for transmitting the data. In one aspect, the one or more communication channels may be determined based on the priority information. In one embodiment, the data may be transmitted via each of the plurality of communication channels when the data is assigned with the priority flag. Examples of the plurality of communication channels may include, but not limited to, a Satellite Communication (SATCOM) channel, a Direct Air to Ground Communication (DA2GC) channel, and an Aircraft to Aircraft Communication (A2A) channel.

In one embodiment, when the data is to be transmitted by the SATCOM channel, the data may first be transmitted to one of a satellite 302-1, 302-2 . . . , and 302-n as shown in the FIG. 3. Upon receipt of the data, the satellite 302 may further transmit the data to ground station 308 via a Ground network 304.

In another embodiment, when the data is to be transmitted by the DA2GC channel, the data may first be transmitted to one of DA2GC tower 306-1, 306-2 . . . , 306-n, diversely located at different locations, as shown in the FIG. 3. Upon receipt of the data, the DA2GC tower 306 may then further transmit the data to the ground station 308. It may be understood that the DA2GC channel is a proposed to provide optimum broadband experience to passengers in the aircraft 100. In one aspect, the DA2GC tower 306 may be operated at 5.8 GHz and 1900 MHz-1920 MHz and connected by backbone networks. Since each DA2GC tower 306 may cover around 30 km to 70 km geographical area, the aircraft 100 flying within the proximity of a DA2GC tower 306 may transmit and/or receive data to the DA2GC tower 306. In one aspect, the data may be accessed from any of the DA2GC tower 306 by other remote data centers via DA2GC hubs and transmit the data to a specific destination.

In yet another embodiment, when the data is to be transmitted by the A2A channel, the data may be relayed by the aircraft 100-1 to another aircraft 100-2, as shown in the FIG. 3. The other aircraft 100-2, upon receipt of the data, may further transmit the data to the ground station 308 by using at least one of the SATCOM channel and the DA2GC channel as described above. In one embodiment, the A2A channel may use, but not limited, Automatic Dependent Surveillance-Broadcast (ADS-B), Ku band, High Frequency (HF), Very High Frequency (VHF), Multispectral Scanner (MSS) and Ultra High Frequency (UHF).

In order to elucidate the functioning of the aforementioned modules, consider an example where the data pertaining to the aircraft 100 is to be transmitted to the ground station 308 by the CANS 102. FIG. 3 illustrates the network implementation for transmitting the data via at least one of the SATCOM channel, the DA2GC channel, and the A2A channel. As shown in the FIG. 3, a plurality of aircraft 100-1, 100-2 . . . , and 100-5 are flying in the airspace. It may be understood that each of the aircraft 100-1, 100-2 . . . , and 100-5 have different system components, wherein each system component is capable of generating a continuous stream of the data. Further, it may be understood that each aircraft 100 may be employed with the CANS 102 for transmitting the data to the ground station 308.

In order to transmit the data generated by each system component, at first, the data receiving module 212 may receive the data from the different system components. In one aspect, the data receiving module 212 receives the data from the ANoS such as turbine Network of System (NoS) 201-1, seat based NoS 201-2, Passenger based NoS 201-3, Inflight Entertainment (IFE) NoS 201-4, Security NoS 201-5, and a High Priority Aircraft NoS. In addition to the above, the data receiving module 212 may further receive the data from at least one of a secondary NoS and an Auxiliary aircraft NoS. The data receiving module 212 may further manage the data, received from the different system components, based on metadata associated to each sensor. The metadata may include, but not limited to, Device Id and IP address. Upon receiving the data, the data receiving module 212 may segregate the data based on the metadata and further transmit the data to the AIDPS 214 for further analysis. It may be understood that the AIDPS 214 is core data process module configured for analyzing the data. In one aspect, the AIDPS 214 may receive the data either from the data receiving module 212 or a High Priority Aircraft NoS 228. It may be understood that the CANS 102 is a pluggable system that can be plugged with an existing system of the aircraft 100. This pluggable system facilitates aircraft operators to use the CANS 102 anytime, anywhere by using toggle button. On the other hand, the CANS 102 may be disabled when the operator wishes to the existing and/or conventional system employed with each aircraft 100. Based on the above, the operator may be allowed to use only legacy avionic and aircraft communication systems.

The AIDPS 214, upon receipt of the data, analyzes the data with machine learning algorithms to determine the priority information pertaining to the data. The priority information may be determined by comparing the data with the predefined data pattern model. For example, an image processing module inside a cabin network may send an irregular or different set of pilot or devices data to the AIDPS 214. The AIDPS 214 analyzes the data to associate the priority flag with the data, when the data is distinct from the predefined data pattern model. Upon assignment of the priority flag, the AIDPS 214 may transmit the data via best possible available communication channel to responsible stakeholders.

In one embodiment, the AIDPS 214 may comprise the secondary NoS Data Process module 214-2 and the Auxiliary NoS Data Process module 214-3. In one aspect, the data receiving module 212 transmits the data to the secondary NoS Data Process module 214-2 when the data is received from a secondary aircraft NoS. In another aspect, the data receiving module 212 transmits the data to the auxiliary NoS Data Process module 214-3 when the data is received from an auxiliary aircraft NoS.

In an exemplary embodiment, the AIDPS 214 may further comprise an Aircraft Critical NoS Data process module 214-1 for handling high priority Aircraft NoS 228 including, but not limited to, auto pilot NoS, Black Box NoS, fly by wire systems, engine control NoS, Aircrew life support systems, and receiver autonomous integrity monitoring (RAIM) system. Due to the employment of the CANS 102 in the aircraft 100, airlines may have the flexibility to use the CANS 102 along with an existing aircraft safety critical system for transmitting the data to the ground station 308.

Upon receipt of the data, the AIDPS 214 may further invoke the ICSMS 216 for transmitting the data to the ground station 308. In order to transmit the data, the ICSMS 216 transmits a request to the DSE 222 for initiating the communication channel establishment services. In one aspect, the DSE 222 further comprises the SATCOM 222-1, the DA2GC 222-2, the A2A 222-3, and the MCE 222-4. The MCE 222-4 may determine the available communication channels for transmitting the data to the ground station 308. Upon determining the available communication channels, the DSE 222 notifies the available communication channels to the ICSMS 216. In addition to the above, if the data is received from the High Priority Aircraft NoS 228, the ICSMS 216 may direct the DSE 22 to initiate the MCE 222-4 in order to transmit the data via all the available communication channels i.e. the SATCOM 222-1, the DA2GC 222-2, and the A2A 222-3.

Similarly, if the data assigned with the priority flag, the DSE 222 may initiate the MCE 222-4 to transmit the data via all the available communication channels at the same instance. Upon initiating the MCE 222-4, the DSE 222 notifies the ICSMS 216 and thereby triggers all the available communication channels to initiate transmission of the data. It may be understood that if any one of the available communication channels is not available or malfunctions during transmission, the MSE 222-4 may dynamically guide the ICSMS 216 to use all other available communication channels for transmitting the data.

In another embodiment, if the DSE 222 receives the request from the secondary aircraft NoS, the DSE 222 determines all or any of the available communication channels for transmitting the data based on requirement, nature and size of the data. It may be understood that if the size of the data is greater than a predefined data limit and needs to be transmitted to the ground station 308 immediately, the DSE 223 may then initiate the MSE 222-4, otherwise the DSE may use one of the SATCOM 222-1, the DA2GC 222-2, and the A2A 222-3 for transmitting the data. Upon determination of the communication channel, the respective communication network transceiver information may be shared with ICSMS 216 module to transmit the data. In yet another embodiment, if the DSE receives the request from the auxiliary aircraft NoS, the DSE 222 determines the DA2GC 222-2 and the A2A 222-3. This may help in improving data throughput using new spectrum ranges and also provide cost effective transmission of the data between the aircraft 100 and the ground station 308.

Based on the above, the ICSMS 216 may then establish the communication channel transmitting the data by using one or more of the SATCOM 222-1, the DA2GC 222-2, and the A2A 222-3. Thus, in this manner, the CANS 102 transmits the data, associated with the aircraft 100, to the ground station 308. In addition to the aforementioned modules, the CANS 102 further comprises the Communication Failure Management module 218, the Connection Service Monitor Daemon (CSMD) module 220, and the Communication Transponder/Transceiver Interface (CTI) 224. The detail functioning of these modules are described below with the help of FIG. 2.

The Communication Failure Management module 218 may determine the available communication channel(s) and respective interface(s) deployed inside the aircraft 100 for transmitting the data. It may be understood that if any of available communication channel or the respective interface(s) fails or malfunctions during transmission, the Communication Failure Management module 218 notifies the ICSMS 216. Upon such notification, the ICSMS 216 may transmit the data to the ground station 308 via other available communication channel(s). In one aspect, the CSMD module 220 may run at the background and continuously monitors the available communication channels. In one embodiment, the CSMD module 220 notifies all the available communication channels to the ICSMS 216 at specific time intervals.

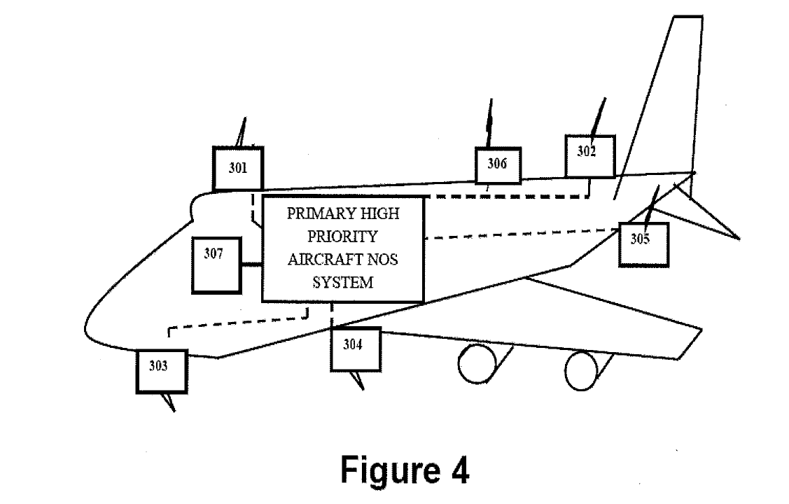

Now referring to FIG. 4. In one embodiment, the CTI 224 is a network connection module or interface between the ICSMS 216 and an aircraft transceiver 232. In one aspect, the CTI 224 is software defined switched device or router or a communication flow manager between the ICSMS 216 and the CTI 224. It may be understood that the CTI 224 facilitates to receive and transmit the data to different transceiver, as shown in the FIG. 4. FIG. 4 illustrates the aircraft 100 is deployed with a plurality of aircraft transceivers 301, 302, 303, 304, 305 and 306 spread across the fuselage to cover at least six directions. It may be understood that the plurality of aircraft transceivers may be software configurable based on communication type High Frequency (HF), Very High Frequency (VHF), Ultra High Frequency (UHF) or the SATCOM. In one embodiment, the aircraft transceiver 307 is a primary high priority aircraft NoS which transmits and receive data via the CTI 224.

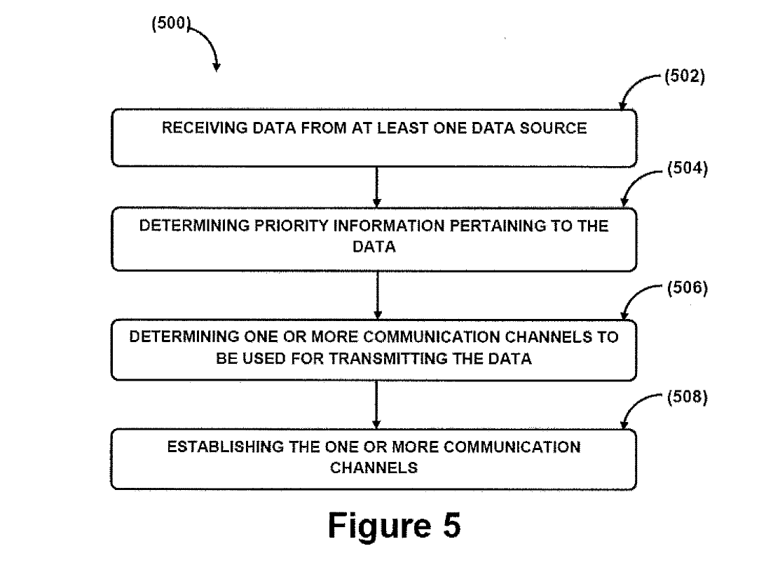

Referring now to FIG. 5, a method 500 for transmitting data, associated with an aircraft, to a ground station via one or more communication channels is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented as described in the CANS 102.

At block 502, data may be received from at least one data source. In one implementation, the data may be received by the data receiving module 212.

At block 504, priority information pertaining to the data may be determined. In one aspect, the priority information may be determined by analyzing the data and a predefined data pattern model. The data may be analyzed by using machine learning algorithms. In one implementation, the priority information may be determined by the Artificial Intelligence based Data Processing System (AIDPS) 214.

At block 506, one or more communication channels, of a plurality of communication channels, to be used for transmitting the data may be determined. In one aspect, the one or more communication channels may be determined based on the priority information. In one implementation, one or more communication channels are used for transmitting the data may be determined by the Intelligent Communication Network Selection and Maintenance Service (ICSMS) 216.

At block 508, the one or more communication channels may be established between the aircraft and a ground station in order to transmit the data to the ground station via the one or more communication channels. In one implementation, the one or more communication channels may be established by the ICSMS 216.

Exemplary embodiments discussed above may provide certain advantages. Though not required to practice aspects of the disclosure, these advantages may include those provided by the following features.

Some embodiments enable a system and a method to efficiently use of communication system without increasing the satellite communication traffic.

Some embodiments enable a system and a method to transmit and receive large dataset via cost effective communication networks.

Some embodiments enable a system and a method to implement multiple communication networks usage at any point of time and simultaneous data transmission to ground network entities

Some embodiments enable a system and a method to transmit flight information to the ground station more frequently as the present invention facilitates to transmit the flight information in a cost effective manner.

Some embodiments enable an aircraft system and method for intelligence emergency situation awareness and fast emergency data communication to ground network and associated systems, devices.

Although implementations for methods and systems for Central Aircraft Network System (CANS) for transmitting data, associated with an aircraft, to a ground station via one or more communication channels have been described in language specific to structural features and/or methods, it is to be understood that the appended claims are not necessarily limited to the specific features or methods described. Rather, the specific features and methods are disclosed as examples of implementations for transmitting the data to the ground station via the one or more communication channels.

1. A method for transmitting data, associated with an aircraft, to a ground station via one or more communication channels, the method comprising:
receiving, by a processor, data from at least one data source;
determining, by the processor, priority information pertaining to the data, wherein the priority information is determined by analyzing the data and a predefined data pattern model, and wherein the data is analyzed by using machine learning algorithms;
determining, by the processor, one or more communication channels, of a plurality of communication channels, to be used for transmitting the data, wherein the one or more communication channels is determined based on the priority information; and
establishing, by the processor, the one or more communication channels between the aircraft and a ground station in order to transmit the data to the ground station via the one or more communication channels.

2. The method of claim 1, wherein the at least one data source comprises a High Priority Aircraft Network of System (NoS), an External Communication Monitoring System, an Aircraft Transponder, an Aircraft Transceiver, a Turbine NoS, Seat based NoS, a Passenger NoS, an In-flight entertainment (IFE) NoS, a Security NoS, a cargo monitoring NoS, an electrical subsystem, and a Temperature Monitoring NoS.

3. The method of claim 1, wherein the priority information is determined by
comparing, by the processor, the data with the predefined data pattern model, and
associating, by the processor, a priority flag with the data when the data, received in a stream, is distinct from the predefined data pattern model, and wherein the priority flag indicates the data comprises priority data.

4. The method of claim 3, wherein the data is transmitted via each of the plurality of communication channels when the data is assigned with the priority flag.

5. The method of claim 1, wherein the plurality of communication channels comprises Satellite Communication (SATCOM) channel, Direct Air to Ground Communication (DA2GC) channel, and Aircraft to Aircraft Communication (A2A) channel.

6. The method of claim 5 further comprises
transmitting, by the aircraft, the data to the ground station via a satellite when a communication channel, established between the aircraft and the ground station, is determined as the SATCOM channel, and
transmitting, by the aircraft, the data to the ground station via a DA2GC tower when a communication channel, established between the aircraft and the ground station, is determined as the DA2GC channel.

7. The method of claim 5 further comprises transmitting the data to the ground station by
relaying, by the aircraft, the data to another aircraft, wherein the other aircraft further transmits the data to the ground station by using at least one of the SATCOM channel and the DA2GC channel,
and wherein the data is relayed to the other aircraft when a communication channel, established between the aircraft and the ground station, is determined as the A2A channel.

8. A Central Aircraft Network System (CANS) for transmitting data, associated with an aircraft, to a ground station via one or more communication channels, the CANS comprising:
a processor; and
a memory coupled to the processor, wherein the processor is capable of executing a plurality of modules stored in the memory, and wherein the plurality of modules comprising:
a data receiving module for receiving data from at least one data source;
an Artificial Intelligence based Data Processing System (AIDPS) for determining priority information pertaining to the data, wherein the priority information is determined by analyzing the data and a predefined data pattern model, and wherein the data is analyzed by using machine learning algorithms; and
an Intelligent Communication Network Selection and Maintenance Service (ICSMS) for
determining one or more communication channels, of a plurality of communication channels, to be used for transmitting the data, wherein the one or more communication channels is determined based on the priority information, and
establishing the one or more communication channels between the aircraft and a ground station in order to transmit the data to the ground station via the one or more communication channels.

9. The CANS of claim 8, wherein the at least one data source comprises a High Priority Aircraft Network of System (NoS), an External Communication Monitoring System, an Aircraft Transponder, an Aircraft Transceiver, a Turbine NoS, Seat based NoS, a Passenger NoS, an In-flight entertainment (IFE) NoS, a Security NoS, a cargo monitoring NoS, an electrical subsystem, and a Temperature Monitoring NoS.

10. The CANS of claim 8, wherein the AIDPS determines the priority information based on Aircraft Network of System (NoS) by
comparing the data with the predefined data pattern model, and
associating a priority flag with the data when the data, received in a stream, is distinct from the predefined data pattern model, and wherein the priority flag indicates the data comprises priority data.

11. The CANS of claim 10, wherein the data is transmitted via each of the plurality of communication channels when the data is assigned with the priority flag.

12. The CANS of claim 8, wherein the plurality of communication channels comprises Satellite Communication (SATCOM) channel, Direct Air to Ground Communication (DA2GC) channel, and Aircraft to Aircraft Communication (A2A) channel.

13. The CANS of claim 12, wherein the ICSMS further
transmits the data to the ground station via a satellite when the ICSMS determines a communication channel as the SATCOM channel, and
transmits the data to the ground station via a DA2GC tower when the ICSMS determines a communication channel as the DA2GC channel.

14. The CANS of claim 12, wherein the ICSMS transmits the data to the ground station by
relaying the data to another aircraft, wherein the other aircraft further transmits the data to the ground station by using at least one of the SATCOM channel and the DA2GC channel,
and wherein the data is relayed to the other aircraft when a communication channel, established between the aircraft and the ground station, is determined as the A2A channel.

15. A non-transitory computer readable medium embodying a program executable in a computing device for transmitting data, associated with an aircraft, to a ground station via one or more communication channels, the program comprising a program code:
a program code for receiving data from at least one data source;
a program code for determining priority information pertaining to the data, wherein the priority information is determined by analyzing the data and a predefined data pattern model, and wherein the data is analyzed by using machine learning algorithms;
a program code for determining one or more communication channels, of a plurality of communication channels, to be used for transmitting the data, wherein the one or more communication channels is determined based on the priority information; and
a program code for establishing the one or more communication channels between the aircraft and a ground station in order to transmit the data to the ground station via the one or more communication channels.
